(19) United States
(12) Patent Application Publication
(10) Pub. No.: US 2014/0084838 A1
(43) Pub. Date: Mar. 27, 2014

(54) NUMERICAL CONTROLLER HAVING FUNCTION FOR SWITCHING BETWEEN PRESSURE CONTROL AND POSITION CONTROL

(71) Applicant: FANUC Corporation, Minamitsuru-gun (JP)

(72) Inventor: Kouichirou HORIGUCHI, Minamitsuru-gun (JP)

(73) Assignee: FANUC Corporation, Minamitsuru-gun (JP)

(21) Appl. No.: 14/032,410

(22) Filed: Sep. 20, 2013

(30) Foreign Application Priority Data
Sep. 24, 2012 (JP) 2012-209805

(51) Int. Cl. H02P 31/00

(52) U.S. Cl. CPC H02P 31/00
USPC 318/560

(57) ABSTRACT

When a numerical controller is notified of switching to pressure control during instructing of position-controlled synchronization, the numerical controller places the synchronization instruction in pause and switches to a pressure-controlled instruction. Then, when it is desired to return from pressure control to position control, a transition from pressure control to position control is effected by resuming the position-controlled synchronization instruction that has been placed in pause hitherto and outputting movement instructions up to the actual position all at once. With this, the actual speed matches the position-controlled speed controlled by the servo control section, thereby reducing a shock at the time of switching from pressure control to position control.

### BACKGROUND OF THE INVENTION

1. Field of the Invention

The present invention generally relates to a numerical controller for controlling a machine tool, and in particular relates to a numerical controller having a function for switching between pressure control and position control.

2. Description of the Related Art

Numerical controllers for controlling servo motors by automatically switching between pressure control and position control using an instruction obtained through pressure feedback control or an instruction obtained through position feedback control, whichever has a smaller instruction value, are well known in the art as disclosed by Japanese Patent Application Laid-Open No. 2008-40886, for example.

In a numerical controller having a servo control section and a numerical control section, the servo control section controls servo motors by automatically switching between pressure control and position control by selecting an instruction obtained through pressure feedback control or an instruction obtained through position feedback control, whichever has a smaller instruction value. The numerical control section outputs position instructions and pressure instructions to the servo control section on the basis of an NC program. When the numerical control section is notified, while instructing position-controlled synchronization, by the servo control section of the switching to pressure control, the numerical control section terminates the position control instruction. Then, when it is desired to return to position control, a transition from pressure control to position control is effected by executing an instruction for reading out and cancelling out the quantity of position deviation accumulated during pressure control.

An operation of a die cushion device that uses a servo motor to control a press axis and a pressure for clamping a sheet metal during a pressing operation by a press machine will now be described.

(1) When the press axis (master axis) comes close to the die cushion axis (slave axis), the die cushion axis (slave axis) performs an escaping motion synchronously with the positions of the press axis (master axis).

(2) After the press axis (master axis) touches the die cushion axis (slave axis), the die cushion axis (slave axis) is placed under pressure control and the synchronization instruction is terminated.

(3) The press axis (master axis) moves to the bottom dead point under a constant pressure.

(4) A transition from pressure control to position control is effected at the bottom dead point by cancelling out the quantity of position deviation accumulated during pressure control.

(5) When the press axis (master axis) leaves the die cushion axis (slave axis), the die cushion axis (slave axis) moves to a standby position under position control.

The servo control section in the numerical controller used in this die cushion operation automatically switches between pressure control and position control by comparing a speed instruction obtained through pressure feedback control and a speed instruction obtained through position feedback control and selecting the speed instruction having the smaller instruction value.

An NC program as shown in FIG. 16 is created to achieve a die cushion operation in a die cushion device and is executed by a numerical controller for die cushion.

In the exemplary program in FIG. 16, “O0001” is a program number; “N1-N8” are sequence numbers; “G100” is a pressure instruction; “Q□□” is a specified pressure value; “G200” is a synchronization instruction; “P□□” is a synchronization data instruction; “WHILE” repeats a macro statement; “[□□]” is a conditional statement; “#□□” is a common variable; “EQ” represents “equal”; “DO1” is a start-of-repeat position; “END1” is an end-of-repeat position; “G91” is an incremental instruction; “G01” is a linear interpolation instruction; “X□□” is an instructed position; “F□□” is a movement speed; “G04” is a dwell (stop) instruction to keep the current state for a time (1000) indicated by code P; “G90” is an absolute instruction; and “M30” is an end-of-program instruction.

A desired pressure value (Q10) is specified in the block of sequence number N1 and a synchronization instruction is executed on the basis of a preregistered synchronization data (P100) in the block of sequence number N2 (see FIG. 17). With this synchronization instruction, in a specified route section of the press axis (master axis), the position of the slave axis corresponding to the current position of the master axis is determined on the basis of a synchronization-instructed slave axis route defined in advance with respect to the positions of the master axis, and the slave axis is positioned at the slave axis position thus determined. When the press axis (master axis) touches the die cushion axis (slave axis), the servo control section switches to pressure control and controls the pressure applied to the die cushion axis (slave axis) so as to keep a desired pressure.

When notified by the servo control section of the switching to pressure control, the numerical control section terminates the processing of the block of sequence number N2 and repeats the blocks of sequence numbers N3 and N4 until variable #100 in the block of sequence number N3 becomes a value other than zero. Subsequently, when the press axis (master axis) reaches the bottom dead point, a value other than zero is input to variable #100. Then, the numerical control section executes the block of sequence number N5.

In the block of sequence number N5, the quantity of position deviation accumulated in the error counter in the servo control section is read with variable #5101 and is cleared to zero by instructing the sign-inverted value of this quantity of position deviation. With this, the servo control section returns from pressure control to position control. After being stopped for one second by instruction P1000 in the block of sequence number N6, the numerical control section executes the block of sequence number N7 and returns the die cushion axis (slave axis) to the standby position under position control.

FIGS. 18 and 19 show a position-time relationship in the press die cushion operation according to a prior art technique.

In the die cushion operation according to this prior art technique, the quantity of position deviation is read out and cancelled out as described in the operation (4) of the die cushion device. This quantity of position deviation is determined from an instruction from the numerical control section and a position fed back from the servo control section. When the quantity of position deviation is read out of the numerical control section, however, information (position deviation) slightly earlier in time is read out. The passing of this information (data) is also delayed. Due to these delays, the quantity of movement corresponding to the quantity of delay cannot be cancelled out and the remaining quantity of position deviation causes a shock to occur upon switching from pressure control back to position control as shown in FIG. 19.

More specifically, the delay occurs because the instruction for reading out and cancelling out the quantity of position deviation is executed at the time of transition from pressure control to position control. Here, the delay refers to the sum of the time delay of the quantity of position deviation and the delay produced when this quantity of position deviation is read out. Due to this delay, the quantity of movement corresponding to the delay cannot be cancelled out and a shock occurs upon switching back to position control.

### SUMMARY OF THE INVENTION

In view of the above problem of the prior art technique, an object of the present invention is to provide a numerical controller having a function for switching between pressure control and position control, capable of reducing shocks at the time of switching from pressure control to position control.

According to the present invention, when a numerical control unit is notified, while instructing position-controlled synchronization in a numerical controller, by a servo control section of the switching to pressure control, the numerical control unit places the synchronization instruction in pause and switches to a pressure-controlled instruction. Then, when it is desired to return from pressure control to position control, a transition from pressure control to position control is effected by resuming the position-controlled synchronization instruction that has been placed in pause hitherto and outputting movement instructions up to the actual position all at once.

The numerical controller according to the present invention has a function for switching between pressure control and position control and includes a servo control section that controls a servo motor by automatically switching between position control and pressure control by selecting an instruction obtained through position feedback control or an instruction obtained through pressure feedback control, whichever has a smaller instruction value, and a numerical control section that determines a position of the slave axis with respect to a position of the master axis and outputs a position instruction for the slave axis to the servo control section in order to achieve position control so that the position of the slave axis synchronously follows the position of the master axis. The servo control section notifies the numerical control section whether the servo control section is under position control or pressure control. If the numerical control section is notified by the servo control section that switching from position control to pressure control has taken place during execution of position control, the numerical control section places the position control in a synchronization pause state in which the position of the slave axis with respect to the position of the master axis is determined but output of the position instruction for the slave axis to the servo control section is stopped, and resumes position control by resuming the output of the position instruction for the slave axis at a predetermine position of the master axis or the slave axis or at a predetermined timing.

The numerical control section can be configured to gradually output instructed quantities of movement up to the synchronization-instructed route of the slave axis according to the speed of the master axis when resuming the output of the position instruction for the slave axis.

The numerical control section can be configured to specify a position of the master axis at which switching from pressure control to position control takes place, determine, from the specified position of the master axis at which the switching takes place, a position at which the output of the position instruction for the slave axis is resumed, and resume the output of position instruction for slave axis at the determined position.

The present invention can provide a numerical controller having a function for switching between pressure control and position control, capable of reducing shocks at the time of switching from pressure control to position control by matching the actual speed and the position-controlled speed controlled by the servo control section.

### BRIEF DESCRIPTION OF THE DRAWINGS

The above and other objects and features of the present invention will become apparent from the following description of embodiments with reference to the accompanying drawings, in which:

FIG. 1 illustrates a die cushion device;

FIG. 2 is a block diagram schematically illustrating the configuration of a numerical controller according to the present invention that controls the die cushion device in FIG. 1;

FIG. 3 illustrates a time-position relationship in the first example of press die cushion operation controlled by the numerical controller in FIG. 2;

FIG. 4 shows an exemplary NC program including instructions to servo motors for driving die cushion members to achieve the pressure control in FIG. 3;

FIG. 5 illustrates die cushion speed instructions at the time of switching from pressure control to position control in the first example of press die cushion operation;

FIG. 6 illustrates a case in which the die cushion axis leaves the press axis at a position other than the bottom dead point, at which the shaft is moving, and operates under position control in the second example of press die cushion operation controlled by the numerical controller in FIG. 2;

FIG. 7 illustrates that, in the operation in FIG. 6, the die cushion axis abruptly stops moving and a shock occurs in the die cushion;

FIG. 8 illustrates a time-position relationship in the second example of press die cushion operation;

FIG. 9 illustrates die cushion speed instructions at the time of switching from pressure control to position control in the second example of press die cushion operation;

FIG. 10 illustrates a time-position relationship in the third example of press die cushion operation controlled by the numerical controller in FIG. 2;

FIG. 11 illustrates die cushion speed instructions at the time of switching from pressure control to position control in the third example of press die cushion operation;

FIG. 12 is a flowchart illustrating an algorithm (first half) of a process for controlling the switching between position control and pressure control that is common to the first, second, and third examples of press die cushion operations;

FIG. 13 is a flowchart (continued from the flowchart in FIG. 12) illustrating an algorithm (second half) of a process for controlling the switching between position control and pressure control in the first example of press die cushion operation;

FIG. 14 is a flowchart (continued from the flowchart in FIG. 12) illustrating an algorithm (second half) of a process for controlling the switching between position control and pressure control in the second example of press die cushion operation;

FIG. 15 is a flowchart (continued from the flowchart in FIG. 12) illustrating an algorithm (second half) of a process for controlling the switching between position control and pressure control in the third example of press die cushion operation;

FIG. 16 illustrates an exemplary NC program for achieving a die cushion operation;

FIG. 17 illustrates a relationship between master axis positions and slave axis positions;

FIG. 18 illustrates a position-time relationship in a press die cushion operation according to the prior art technique; and

FIG. 19 illustrates die cushion speed instructions at the time of switching from pressure control to position control.

### DETAILED DESCRIPTION OF THE PREFERRED EMBODIMENTS

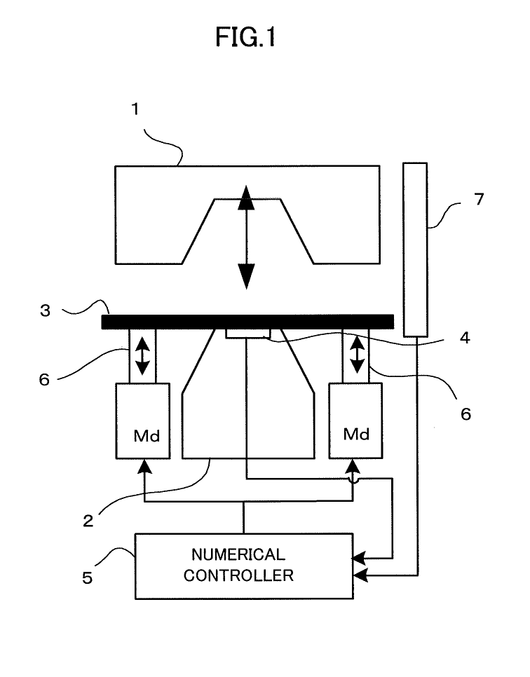

Referring first to FIG. 1, a die cushion device will be described. A die includes an upper die 1 and a lower die 2. The lower die 2 is secured to the base of a press machine (not shown), while the upper die (press) 1 is secured to a press axis, facing the lower die 2. The press axis is driven by a press axis driving source using a motor, hydraulic pressure, or air pressure and drives and moves up and down a clamp shaft (upper die 1) in a constant pattern.

A plurality of die cushion members 6 are provided on the sides of the lower die 2 and are configured so as to be driven by corresponding servo motors Md in the directions indicated by the arrows in FIG. 1. Although two pairs of die cushion members 6 and die cushion servo motors Md are shown in FIG. 1, three, four, or more pairs of die cushion members 6 and die cushion servo motors Md may be provided, or a plurality of die cushion members 6 may be interconnected as a single unit and driven by a single servo motor for die cushion. These servo motors Md are driven and controlled by a numerical controller 5 for die cushion.

The sheet metal (workpiece) 3 to be pressed is placed on the die cushion members 6 and disposed on the lower die 2. A pressure sensor 4 for detecting a pressure applied to the sheet metal (workpiece) 3 is provided in the lower die 2. Pressure signals detected by the pressure sensor 4 are fed back to the numerical controller 5 for die cushion. A position sensor 7, such as a limit switch, for detecting positions of the upper die (press) 1, i.e., positions of the press axis, is also provided. The output of the position sensor 7 is also input to the numerical controller 5.

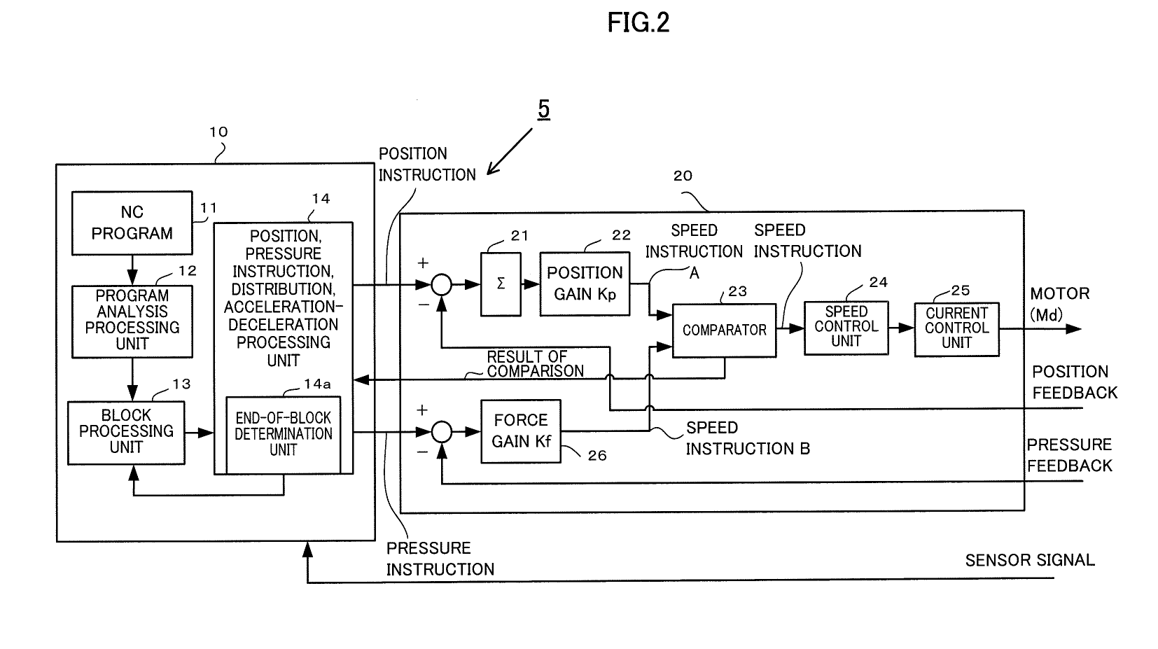

Referring now to FIG. 2, the numerical controller 5 for die cushion will be described.

The numerical controller 5 is roughly divided into a numerical control section 10 and a servo control section 20. The numerical control section 10 receives sensor signals output by the position sensor 7. The numerical control section 10 includes an NC program 11, program analysis processing unit 12, block processing unit 13, and position/pressure instruction/distribution/acceleration-deceleration processing unit 14. The program analysis processing unit 12 sequentially reads and analyzes instructions from the blocks of the NC program 11, converts these instructions to execution data, and stores these data into the block processing unit 13.

The position/pressure instruction/distribution/acceleration-deceleration processing unit 14 reads the execution data block by block out of the block processing unit 13 and, on the basis of these execution data, performs a distribution process to distribute the quantities of movement as the position instructions, executes their acceleration and deceleration processing, and outputs the quantity of movement for each distribution cycle as the position instruction to the servo control section 20. Furthermore, in response to pressure instructions, the position/pressure instruction/distribution/acceleration-deceleration processing unit 14 outputs the instructed pressures as the pressure instruction values to the servo control section 20.

The position/pressure instruction/distribution/acceleration-deceleration processing unit 14 includes an end-of-block determination unit 14a. The end-of-block determination unit 14a determines whether or not the entire quantity of movement in the position instruction in the block currently being executed has been transferred to the servo control section; if it is determined that the entire quantity of movement has been transferred to the servo control section, the end-of-block determination unit 14a notifies the block processing unit 13 of the completion of the processing in this block (i.e., the execution of instructions in the current block has been completed). Receiving this block completion notification, the block processing unit 13 passes execution data of the instruction in the next block to the position/pressure instruction/distribution/acceleration-deceleration processing unit 14, so that the next block is executed.

On the other hand, the servo control section 20 includes an error counter 21, position gain Kp unit 22, comparator 23, speed control unit 24, and current control unit 25 that form a position loop control section, as well as a force gain unit 26 that forms a pressure control section.

The error counter 21 calculates the quantity of position deviation from positions instructed by the numerical control section 10 and positions fed back from a position/speed detector provided in a servo motor or another unit. A position-controlled speed instruction A is determined by multiplying the calculated quantity of position deviation by a position gain Kp. A pressure-controlled speed instruction B is determined by calculating the quantity of pressure deviation from pressures instructed by the numerical control section 10 and pressures fed back from the pressure sensor 4 and multiplying the calculated quantity of pressure deviation by a force gain Kf.

The comparator 23 compares the position-controlled speed instruction A with the pressure-controlled speed instruction B and selects the speed instruction A or the speed instruction B, whichever has a smaller instruction value, as the speed instruction to the speed control unit 24. On the basis of this speed instruction and the speed fed back from the speed detector (not shown), the speed control unit 24 performs speed feedback control and determines a torque instruction (current instruction) to drive and control the servo motors.

As described above, the numerical controller 5 performs position control or pressure control by comparing the position-controlled speed instruction A with the pressure-controlled speed instruction B in the comparator 23 and selecting the speed instruction A or the speed instruction B, whichever has a smaller instruction value (i.e., when the speed instruction A is greater than the speed instruction B, the speed instruction B is selected to perform pressure control). The numerical controller 5 notifies the numerical control section 10 of the result of comparison in the comparator 23 (i.e., whether the control has been switched to position control or pressure control).

In the following, several examples of press die cushion operations will be described, in which a servo motor Md for die cushion is driven and controlled by the numerical controller 5 by switching between position control and pressure control as described above.

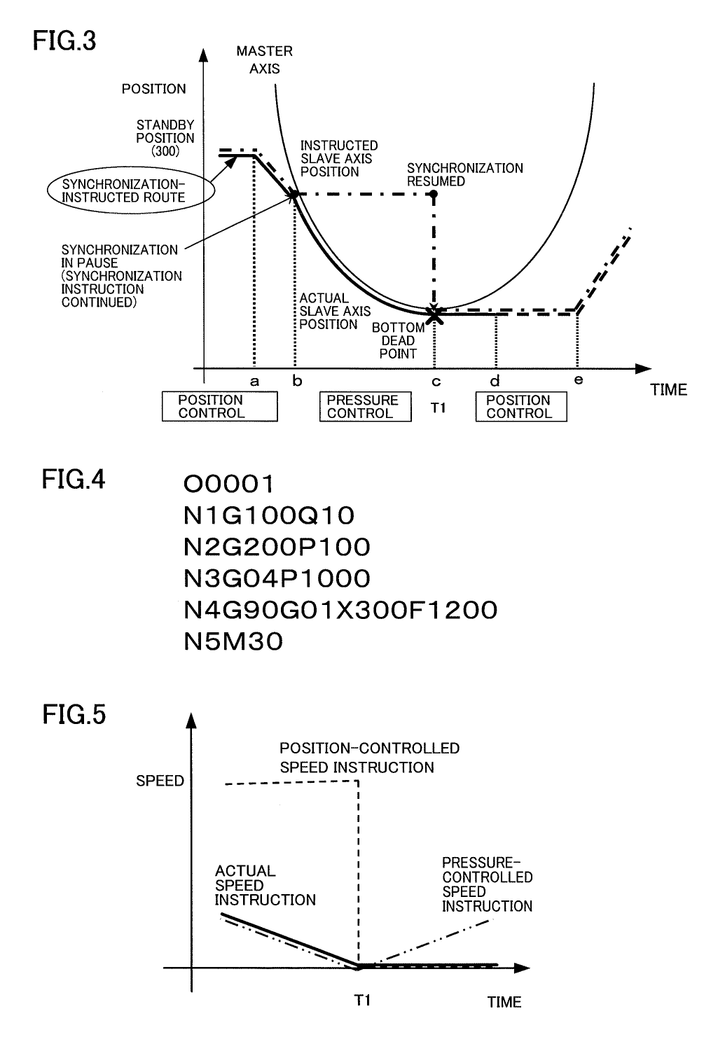

Referring now to FIGS. 3-5, a first example of press die cushion operation will be described.

FIG. 3 illustrates a time-position relationship in this press die cushion operation.

The servo control section 20 in the numerical controller 5 for die cushion controls die cushion members by automatically switching between pressure control and position control by selecting a speed instruction A obtained through position feedback control or a speed instruction B obtained through pressure feedback control, whichever has a smaller instruction value.

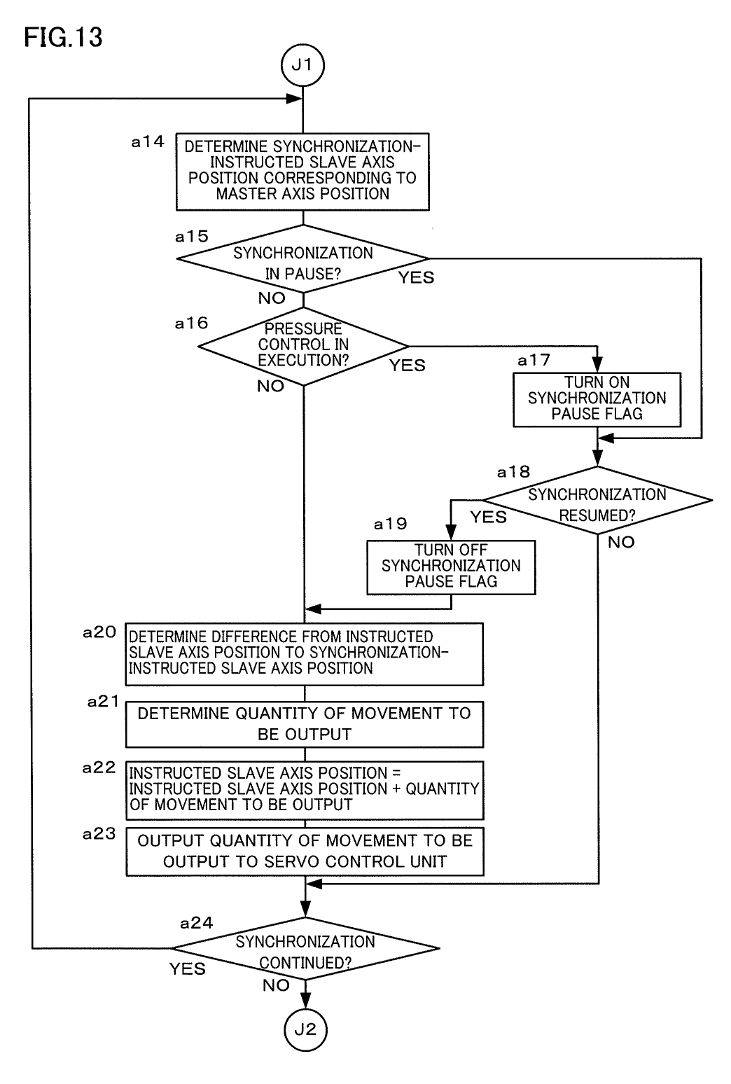

In the prior art technique, when the press axis (master axis) touches the die cushion axis (slave axis) and the servo control section switches to pressure control, the numerical control section 10 terminates the synchronization instruction and executes an instruction in the next block. In contrast, in this example of press die cushion operation, the synchronization instruction is not terminated but is placed in “pause”. The “pause” of the synchronization instruction refers to a state in which the synchronization instruction block is kept in execution as it is on the NC program such that the synchronization instruction can be resumed (see Steps a15-a18 in FIG. 13).

In this state, when the press axis (upper die 1) reaches the bottom dead point, the numerical control section 10 resumes the synchronization instruction that has been placed in pause hitherto. The event of the press axis (upper die 1) reaching the bottom dead point can be recognized from the position information of the upper die 1 obtained from the position sensor 7, for example. The synchronization instruction can be issued without delay because the entire quantity of movement up to the position of the die cushion axis corresponding to the current position of the press axis (upper die 1) on the route defined by synchronization data is output all at once. With this, if the die cushion axis has operated along a route as instructed by synchronization instructions, the actual position of the die cushion axis coincides, at the bottom dead point, with the position instructed by a synchronization instruction and therefore the quantity of position deviation is eliminated by this synchronization instruction. This enables the switching from pressure control to position control to take place without occurrence of any shock.

FIG. 4 shows an example of an NC program including instructions to a servo motor Md for driving a die cushion member 6 to achieve such a pressure control.

“O0001” is a program number; “N1-N5” are sequence numbers; “G100” is a pressure instruction; “Q□□” is a specified pressure value; “G200” is a synchronization instruction; “P□□” is a synchronization data instruction; “G04” is a dwell (stop) instruction to keep the current state as it is for the time (1000) specified by code P; “G90” is an absolute instruction; and “M30” is an end-of-program instruction.

A desired pressure value (Q10) is specified in the block of sequence number N1 and a synchronization instruction is executed on the basis of a preregistered synchronization data (P100) in the block of sequence number N2 (see FIG. 17). With this synchronization instruction, in a specified route section of the press axis as the master axis, a position of the slave axis corresponding to the current position of the master axis is determined on the basis of a synchronization-instructed slave axis route defined in advance in association with the master axis positions, and the slave axis is positioned at this slave axis position. When the press axis (master axis) touches the die cushion axis (slave axis), the servo control section switches to pressure control and controls the pressure applied to the die cushion axis (slave axis) so as to keep a desired pressure.

In this state, when the press axis (upper die 1) reaches the bottom dead point, the numerical control section 10 resumes the synchronization instruction that has been placed in pause hitherto. The event of the press axis (upper die 1) reaching the bottom dead point can be recognized from the position information of the upper die 1 obtained from the position sensor 7, for example. The synchronization instruction can be issued without delay, because the entire quantity of movement up to the position of the die cushion axis corresponding to the current position of the press axis (upper die 1) on the route defined by the synchronization data is output all at once. With this, if the die cushion axis has operated along a route as instructed by synchronization instructions, the actual position of the die cushion axis coincides, at the bottom dead point, with the position instructed by a synchronization instruction and therefore the quantity of position deviation is eliminated by this synchronization instruction. This enables the switching from pressure control to position control to take place without occurrence of any shock.

Then, the die cushion axis is stopped for one second (time d to time e) by the instruction P1000 in the block of sequence number N3, and then the block of sequence number N4 is executed before returning to the standby position under position control (after time e).

FIG. 3 shows a positional relationship between the master axis (upper die 1) and the slave axis (die cushion member 6) when this NC program is executed to control the die cushion member 6 by driving the servo motor Md. In FIG. 3, the horizontal axis indicates the time and the vertical axis indicates the position. The solid line indicates the positions of the upper die (press) 1, the dot-and-dash line indicates the instructed positions of the die cushion member 6, and the dashed line indicates the actual positions (fed-back position values) of the die cushion member 6. The positions of the die cushion member 6 up to time d are preset as the synchronization-instructed route (thick solid line). The period from time d to time e is a dwell period and time e is the time at which the return to the initial position is initiated.

The die cushion member 6 is held at the standby position “300” as the press start position (under position control).

After the NC program (program number O0001) in FIG. 4 is executed, “G100 Q10” of sequence number N1 is executed and the pressure instruction Q=10 is output from the numerical control section 10 to the servo control section 20. Then, “G200 P100” of sequence number N2 is executed and the numerical control section 10 executes synchronization instructions on the basis of the preregistered synchronization data (P100).

When the upper die (press) 1 moves downward, sensor signals (detection signals) output from the position sensor 7 are input to the numerical controller 5 (numerical control section 10). When the point at time a is detected, the numerical control section 10 in the numerical controller 5 starts to move the die cushion member 6 with the synchronization instructions.

The comparator 23 in the servo control section 20 compares a position-controlled speed instruction A and a pressure-controlled speed instruction B. Initially, the speed instruction B is larger, because the upper die (press) 1 is not in abutment with the sheet metal 3, that is, the value fed back from the pressure sensor 4 is small and the quantity of pressure deviation is large. On the other hand, the die cushion member 6 is held at the press start position in the initial stage, so the position-controlled speed instruction A is smaller, that is, the quantity of position deviation is small. Therefore, with position-controlled synchronization instructions, the servo control section 20 initially drives the servo motor Md according to the positions and speeds of the upper die (press) 1 to start to move the die cushion member 6 downward at time a.

Since the speed of the upper die (press) 1 moving toward the lower die 2 is faster than the speed of movement of the lower die 2, the upper die (press) 1 catches up to the sheet metal 3 and the die cushion member 6 and collides with the lower die 2 at time b, as shown in FIG. 3. Since the pressure deviation decreases as the position deviation increases, the pressure-controlled speed instruction B becomes smaller than the position-controlled speed instruction A. This causes the switching from the position-controlled speed instruction to the pressure-controlled speed instruction to take place. A signal sent from the comparator 23 to the numerical control section 10 as the result of comparison notifies the numerical control section 10 of information (result of comparison) indicating the occurrence of switching from the position-controlled speed instruction to the pressure-controlled speed instruction. Since the pressure instruction at this time is “Q=10” instructed in the block of sequence number N1, the pressure is controlled so as to match the pressure Q=10.

Receiving the result of comparison from the comparator 23 in the servo control section 20, the numerical control section 10 places the synchronization instruction in pause, instead of terminating it. As described above, the pause of the synchronization instruction refers to a state in which the synchronization instruction block is kept in execution as it is on the NC program such that the synchronization instruction can be resumed.

Then, at time c at which the upper die (press) 1 reaches the lowermost point and stops moving and the die cushion member 6 also reaches the lowermost point (see FIG. 3), the synchronization instruction is released from the state of pause and is shifted into a state in which the synchronization instruction can be resumed. In this way, the resumption of the synchronization instruction can be determined on the basis of the master axis position, for example.

When the synchronization instruction is resumed, the quantity of movement is output from the position/pressure instruction/distribution/acceleration-deceleration processing unit 14 in the numerical control section 10 to the servo control section 20 and the quantity of position deviation in the error counter 21 becomes zero or an extremely small value. With this, the switching from pressure control to position control takes place and the synchronization instruction causes the servo motor Md (die cushion member 6) to be held and stopped at the instructed position (bottom dead point).

FIG. 5 illustrates die cushion speed instructions at the time of switching from pressure control to position control.

Before time c, since the pressure-controlled speed instruction (speed instruction B) is smaller than the position-controlled speed instruction (speed instruction A), the servo control section 20 controls the slave axis (die cushion 6) in response to pressure-controlled speed instructions. After time T1 (in FIG. 3, time c at which the bottom dead point is reached), since the position-controlled speed instruction (speed instruction A) is smaller than the pressure-controlled speed instruction (speed instruction B), the servo control section 20 controls the slave axis (die cushion 6) in response to position-controlled speed instructions.

When the synchronization instruction is resumed, the numerical control section 10 controls the positions of the slave axis such that the lower die 2 (slave axis) moves along a synchronization-instructed route. Whether the movement control is to be continued or not along the synchronization-instructed route can be determined on the basis of the positions of the master axis (upper die (press) 1) (i.e., sensor signals output from the position sensor). In FIG. 3, the movement of the lower die 2 (slave axis) is controlled along the synchronization-instructed route up to time d.

This state is maintained for the time (1000) indicated by code P in the dwell (stop) instruction. Subsequently, the instruction in the block of next sequence number N4 is executed. With this, the position/pressure instruction/distribution/acceleration-deceleration processing unit 14 performs distribution processing to move the lower die 2 (slave axis) at speed F=1200 to a press start position X=300 and outputs distributed movement instructions to the servo control section 20.

At this time, since the upper die (press) 1 has moved upward leaving the sheet metal 3, lower die 2, and die cushion member 6, the pressure deviation is large and the position deviation is small in the servo control section 20. Accordingly, the position-controlled speed instruction A is selected and position control is performed so that the die cushion member 6 is positioned at the initial press start position (X300) as shown in FIG. 3. Then, the processing of the NC program ends (M30).

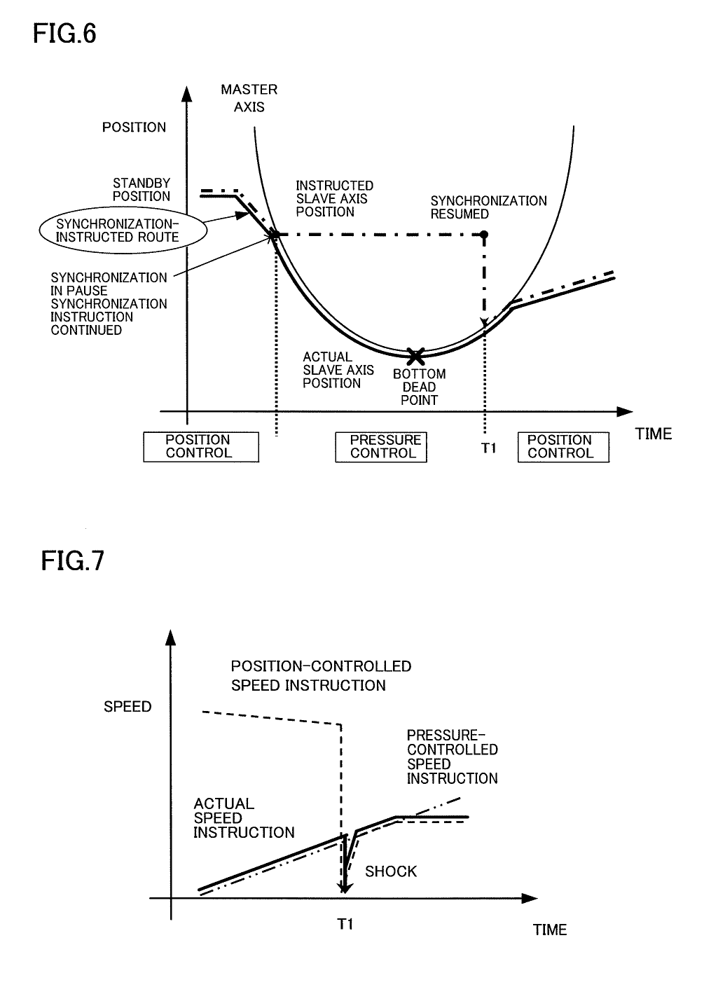

Referring now to FIGS. 6-9, a second example of press die cushion operation will be described.

FIG. 6 illustrates a case in which the die cushion axis leaves the press axis at a position other than the bottom dead point and operates under position control. FIG. 7 illustrates that, in the operation in FIG. 6, the die cushion axis abruptly stops moving and a shock occurs in the die cushion.

In the first example of press die cushion operation described above, the switching to position control at the bottom dead point, at which the shafts stop, does not entail any shock, but the switching to position control at a position other than the bottom dead point, at which the shafts are moving, entails a shock when the die cushion axis leaves the press axis and starts to operate under position control. This is because, when the synchronization instruction is resumed at time T1 as shown in FIG. 6, the entire quantity of position deviation is eliminated at time T1 and consequently the position-controlled speed instruction A becomes smaller than the pressure-controlled speed instruction B. With this, the servo control section 20 switches from pressure control to position control and the die cushion axis as the slave axis abruptly stops moving as shown in FIG. 7.

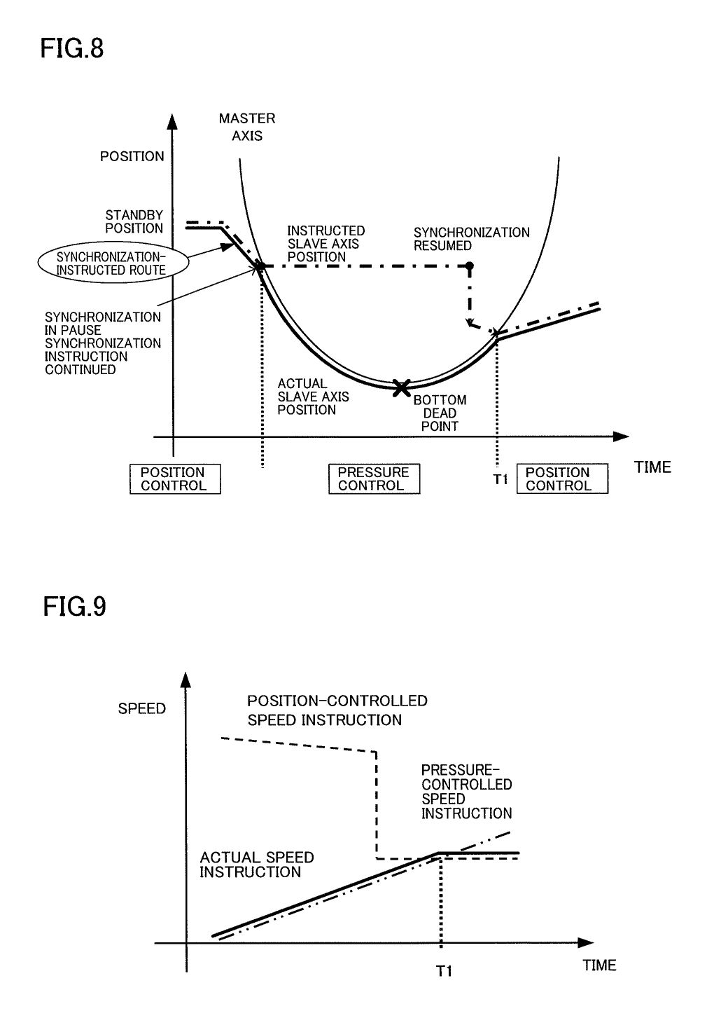

To solve this problem, when the synchronization instruction is resumed, a certain quantity of position deviation is left by outputting pulses up to the vicinity of the instructed position, instead of outputting all the pulses up to the instructed position, as shown in FIG. 8. From the vicinity of the instructed position to the position at which synchronization is resumed, the quantity of position deviation is gradually decreased by gradually outputting movement instructions at a speed equal to the speed of the master axis. With this, speed instructions become continuous at the time of switching from pressure control to position control as shown in FIG. 9 and the shock can be reduced accordingly. Since movement instructions are output to the slave axis according to the speed of the master axis, the shock at the time of switching from pressure control to position control can be reduced even if the actual position is slightly displaced from the position defined by the synchronization data. The distance from the position at which synchronization is resumed to the vicinity of the instructed position and the speed of movement of the die cushion axis (slave axis) from the vicinity of the instructed position to the position at which synchronization is resumed depend on the speed of the press axis as the master axis.

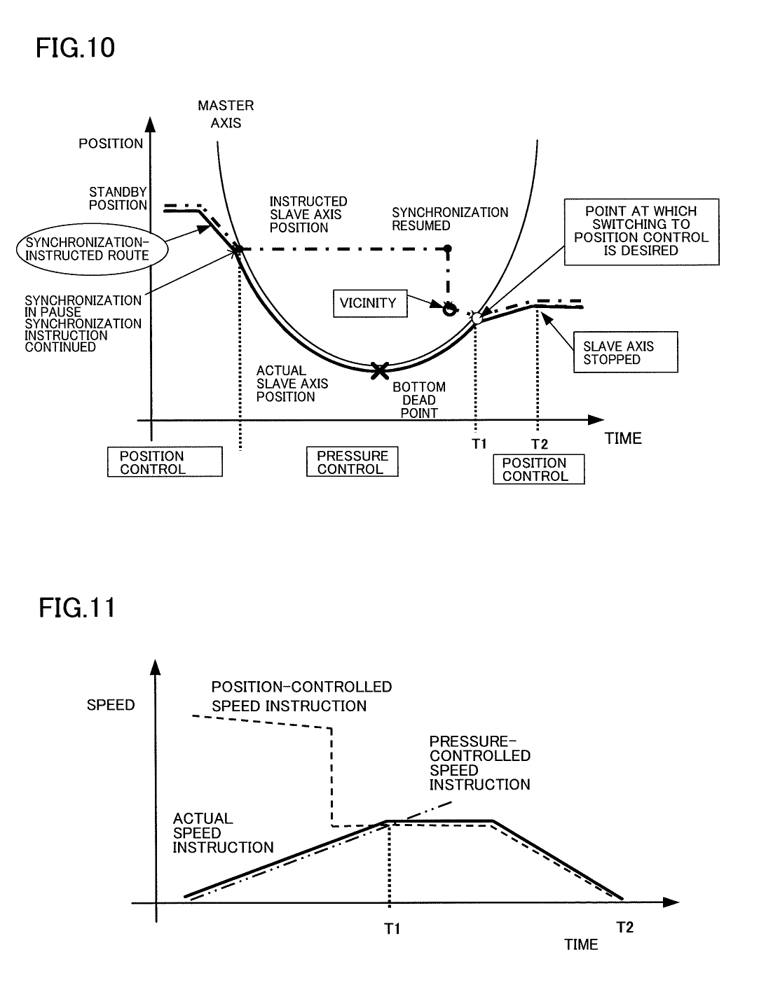

Referring now to FIGS. 10 and 11, a third example of press die cushion operation will be described.

A point of switching from pressure control to position control is specified in advance in the synchronization data in a synchronization instruction. The numerical controller 5 monitors the current position and speed of the press axis (master axis) and pauses until the press axis (master axis) reaches a point at which synchronization is to be resumed, which point is slightly before the point of switching from pressure control to position control, as shown in FIG. 10.

When the press axis (master axis) reaches the point at which synchronization is to be resumed, movement instructions up to the vicinity of the synchronization position are output all at once and then the movement of the die cushion axis (slave axis) is instructed such that the speed of the die cushion axis (slave axis) becomes equal to the speed of the master axis at the point of switching from pressure control to position control, as shown in FIG. 11.

This enables smooth switching from pressure control to position control at the point at which the switching to position control is desired. Then, the die cushion axis (slave axis) can leave the press axis (master axis) and operate under position control.

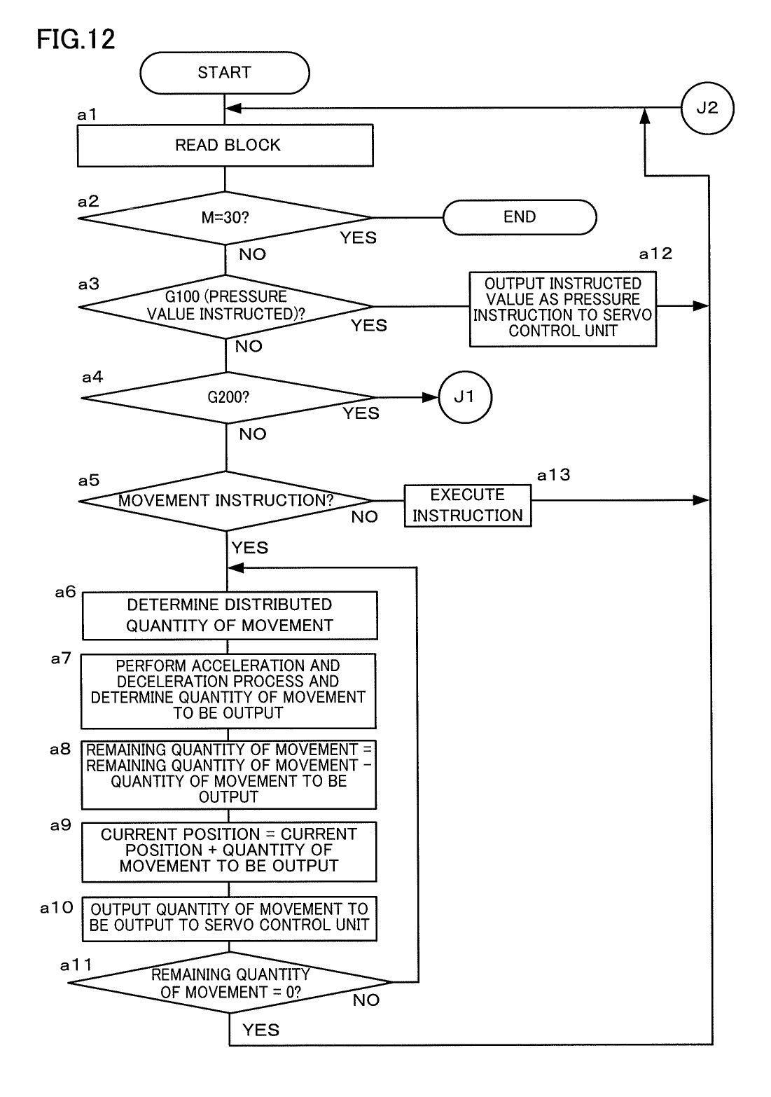

The flowcharts in FIGS. 12-15 illustrate an algorithm executed by the processor in the numerical control section 10 in FIG. 2 as a process performed by the position/pressure instruction/distribution/acceleration-deceleration processing unit 14.

### (1) PROCESS FOR CONTROLLING THE SWITCHING BETWEEN POSITION CONTROL AND PRESSURE CONTROL IN THE FIRST EXAMPLE OF PRESS DIE CUSHION OPERATION (FIGS. 12 AND 13)

The algorithm of a process for controlling the switching between position control and pressure control in the first example of press die cushion operation includes the process illustrated in the flowchart shown in FIG. 12 and its continuation process illustrated in the flowchart FIG. 13. The synchronization pause flag is initially set to off.

[Step a1] The processor for executing the process for the position/pressure instruction/distribution/acceleration-deceleration processing unit 14 in the numerical control section 10 reads, out of the block processing unit 13, those data in an NC program which was converted to execution data.

[Step a2] Whether the instruction thus read out of the block is an end-of-program instruction (“M30”) or not is determined; if it is an end-of-program instruction (YES), this process ends; if it is not an end-of-program instruction (NO), the process proceeds to Step a3.

[Step a3] Whether the instruction read out of the block is a pressure value instruction G100 or not is determined; if it is a pressure value instruction (YES), the process proceeds to Step a12; if it is not a pressure value instruction (NO), the process proceeds to Step a4.

[Step a4] Whether the instruction read out of the block is a synchronization instruction G200 or not is determined; if it is a synchronization instruction (YES), the process proceeds to Step a14 (FIG. 13); if it is not a synchronization instruction (NO), the process proceeds to Step a5.

[Step a5] Whether the instruction read out of the block is a movement instruction or not is determined; if it is not a movement instruction (NO), the process proceeds to Step a13; if it is a movement instruction (YES), the process proceeds to Step a6.

[Step a6] The quantity of movement is determined for each distribution cycle on the basis of the instruction content (linear interpolation, circular interpolation, speed, target position, etc.) of the movement instruction instructed in this block.

[Step a7] An acceleration and deceleration process is performed on the quantity of movement for each distribution cycle and the quantity of movement to be output is determined.

[Step a8] The “remaining quantity of movement ” stored in the register is updated by subtracting the quantity of movement to be output determined in Step a7 from the remaining quantity of movement (remaining quantity of movement←remaining quantity of movement−quantity of movement to be output). The initial value of the “remaining quantity of movement” stored in the register is the quantity of movement instructed in this block.

[Step a9] The current position instructed by the numerical control section 10 to the servo control section 20 is updated. More specifically, the current position is updated by adding the quantity of movement to be output determined in Step a7 to the “current position” stored in the register (current position←current position+quantity of movement to be output).

[Step a10] Next, the quantity of movement to be output determined in Step a7 is output to the servo control section 20.

[Step a11] Whether the remaining quantity of movement is zero or not is determined; if the remaining quantity of movement is zero (YES), the process returns to Step a1. If the remaining quantity of movement is not zero (NO), the process returns to Step a6 to execute the processing from Step a6 to Step a10 (the distributed quantities of movement are determined, the acceleration and deceleration process is performed, and the quantity of movement to be output for each distribution cycle is output to the servo control section 20) in each distribution cycle. Then, the processing from Step a6 to Step a10 is repeated until the remaining quantity of movement becomes zero. When the remaining quantity of movement becomes zero, the process returns to Step a1.

[Step a12] The instructed value is output as the pressure instruction to the servo control section and then the process returns to Step a1.

[Step a13] The instruction is executed and then the process returns to Step a1.

[Step a14] A synchronization-instructed position of the slave axis corresponding to the position of the master axis is determined.

[Step a15] Whether synchronization is in pause or not is determined; if synchronization is in pause (YES), the process proceeds to Step a18; if synchronization is not in pause (NO), the process proceeds to Step a16.

[Step a16] Whether pressure control is in execution or not is determined; if pressure control is in execution (YES), the process proceeds to Step a17; if pressure control is not in execution (NO), the process proceeds to Step a20.

[Step a17] A synchronization pause flag is turned on and then the process proceeds to Step a18.

[Step a18] Whether synchronization is resumed or not is determined; if synchronization is resumed (YES), the process proceeds to Step a19; if synchronization is not resumed (NO), the process proceeds to Step a24. Here, whether synchronization is resumed or not can be determined on the basis of the positions of the master axis (upper die 1) (more specifically, sensor signals output from the position sensor 7), for example.

[Step a19] The synchronization pause flag is turned off and then the process proceeds to Step a20.

[Step a20] A difference from the instructed position of the slave axis to the synchronization-instructed position of the slave axis is determined.

[Step a21] The quantity of movement to be output is determined.

[Step a22] The instructed position of the slave axis is updated by adding the quantity of movement to be output determined in Step a21 to the instructed position of the slave axis (instructed position of slave axis←instructed position of slave axis+quantity of movement to be output).

[Step a23] The updated quantity of movement to be output is output to the servo control section.

[Step a24] Whether synchronization is continued or not is determined; if synchronization is continued (YES), the process returns to Step a14 to continue the process; if synchronization is not continued (NO), the process returns to Step a1. Here, whether synchronization is continued or not can be determined on the basis of the positions of the master axis (upper die 1) (more specifically, sensor signals output from the position sensor), for example. Synchronization is continued up to a preset position and then synchronization is terminated.

If the position at which synchronization is resumed in Step a18 and the position at which synchronization is not continued in Step a24 are the bottom dead point of the master axis, the switching from pressure control to position control takes place at the bottom dead point and the synchronization instruction block ends.

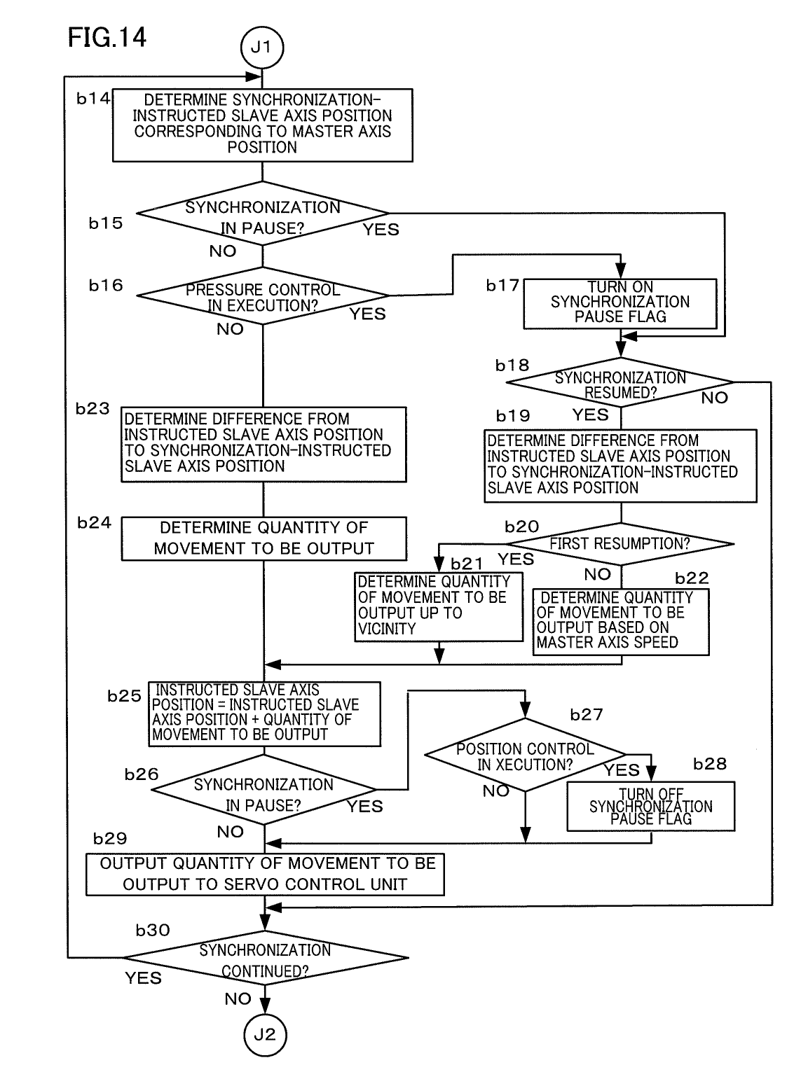

### (2) PROCESS FOR CONTROLLING THE SWITCHING BETWEEN POSITION CONTROL AND PRESSURE CONTROL IN THE SECOND EXAMPLE OF PRESS DIE CUSHION OPERATION (FIGS. 12 AND 14)

The algorithm of a process for controlling the switching between position control and pressure control in the second example of press die cushion operation includes the process illustrated in the flowchart in FIG. 12 and its continuation process illustrated in the flowchart in FIG. 14.

In the processing in Step a4 in the flowchart in FIG. 12, if the instruction in the block is determined to be a synchronization instruction G200, the process proceeds to Step a14 in the flowchart in FIG. 13 in the process for controlling the switching between position control and pressure control in the first example of press die cushion operation described above; in the process for controlling the switching between position control and pressure control in this second example of press die cushion operation, the process proceeds to Step b14 in the flowchart in FIG. 14, instead of Step a14 in the flowchart in FIG. 13.

[Step b14] A synchronization-instructed position of the slave axis corresponding to the position of the master axis is determined.

[Step b15] Whether synchronization is in pause or not is determined; if synchronization is in pause (YES), the process proceeds to Step b18; if synchronization is not in pause (NO), the process proceeds to Step b16.

[Step b16] Whether pressure control is in execution or not is determined; if pressure control is in execution (YES), the process proceeds to Step b17; if pressure control is not in execution (NO), the process proceeds to Step b23.

[Step b17] A synchronization pause flag is turned on and then the process proceeds to Step b18.

[Step b18] Whether synchronization is resumed or not is determined; if synchronization is resumed (YES), the process proceeds to Step b19; if synchronization is not resumed (NO), the process proceeds to Step b30.

[Step b19] A difference from the instructed position of the slave axis to the synchronization-instructed position of the slave axis is determined.

[Step b20] Whether the synchronization is resumed for the first time or not is determined; if synchronization is resumed for the first time (YES), the process proceeds to Step b21; if synchronization is resumed not for the first time (NO), the process proceeds to Step b22.

[Step b21] The quantity of movement to be output up to the vicinity of the synchronization-instructed position is determined and then the process proceeds to Step b25.

[Step b22] The quantity of movement to be output is determined on the basis of the speed of the master axis and then the process proceeds to Step b25.

[Step b23] A difference from the instructed position of the slave axis to the synchronization-instructed position of the slave axis is determined.

[Step b24] The quantity of movement to be output is determined.

[Step b25] The instructed position of the slave axis is updated by adding the quantity of movement to be output determined in Step b21, b22, or b24 to the instructed position of the slave axis (instructed position of slave axis←instructed position of slave axis+quantity of movement to be output).

[Step b26] Whether synchronization is in pause or not is determined; if synchronization is in pause (YES), the process proceeds to Step b27; if synchronization is not in pause (NO), the process proceeds to Step b29.

[Step b27] Whether position control is in execution or not is determined; if position control is in execution (YES), the process proceeds to Step b28; if position control is not in execution (NO), the process proceeds to Step b29.

[Step b28] The synchronization pause flag is turned off and then the process proceeds to Step b29.

[Step b29] The quantity of movement to be output is output to the servo control section.

[Step b30] Whether synchronization is continued or not is determined; if synchronization is continued (YES), the process returns to Step b14 to continue the process; if synchronization is not continued (NO), the process returns to Step al in FIG. 12.

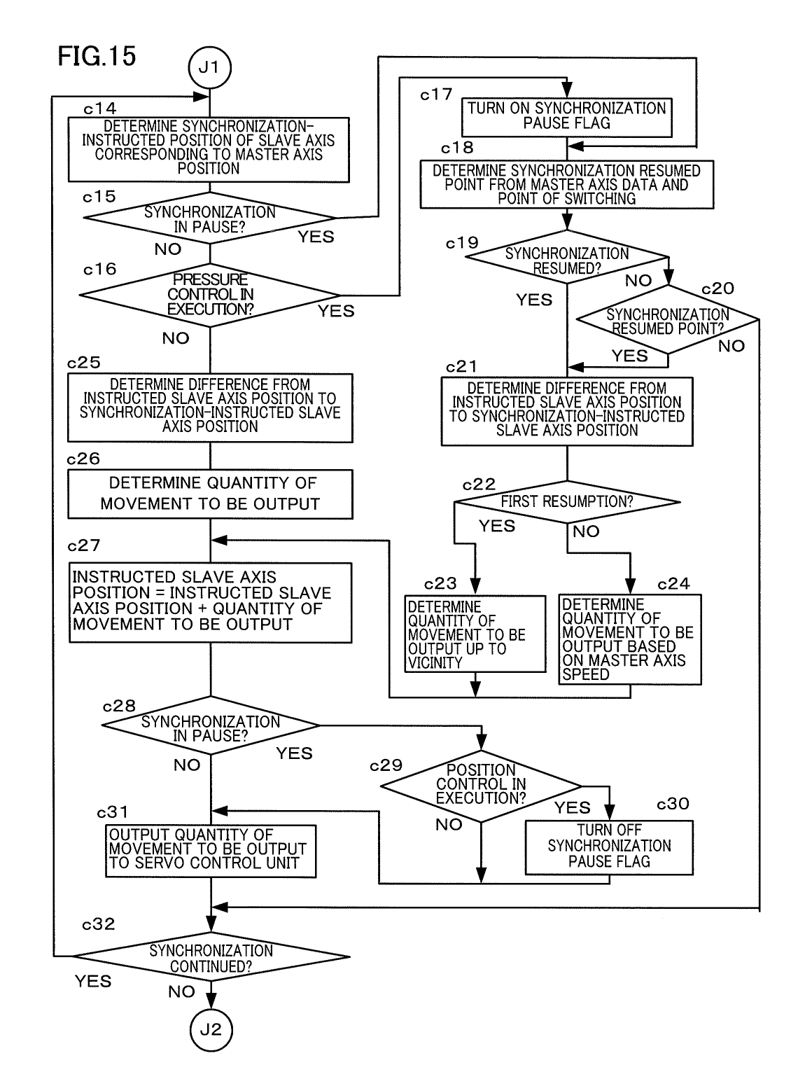

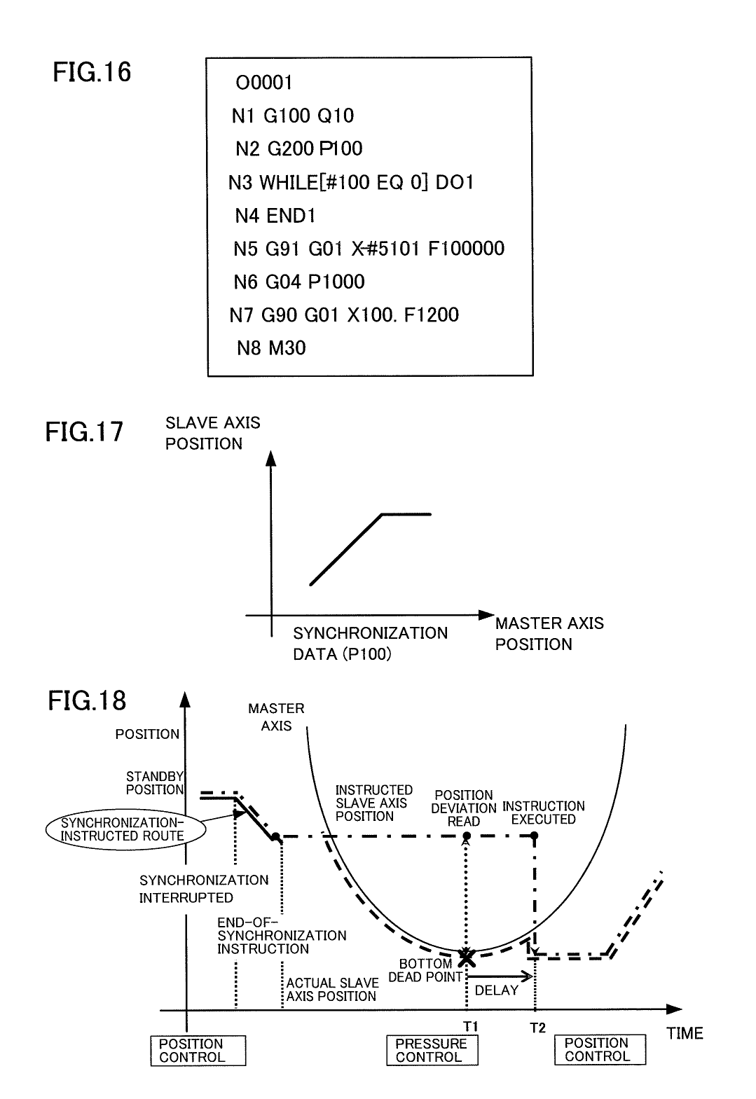

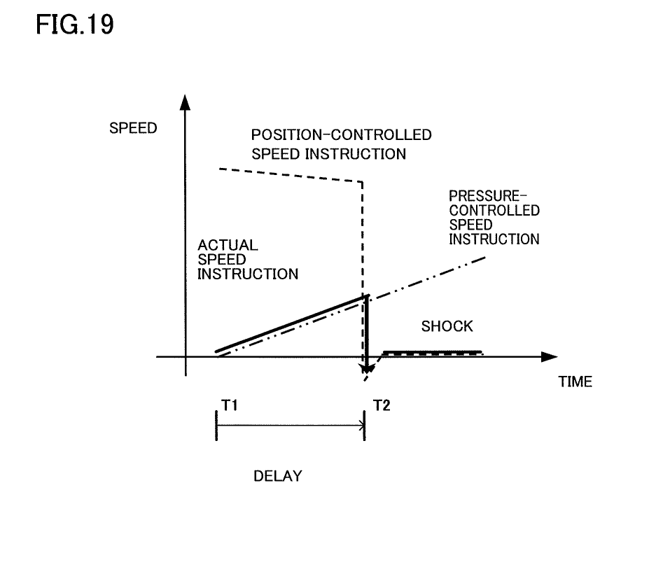

### (3) PROCESS FOR CONTROLLING THE SWITCHING BETWEEN POSITION CONTROL AND PRESSURE CONTROL IN THE THIRD EXAMPLE OF PRESS DIE CUSHION OPERATION (FIGS. 12 AND 15)

The algorithm of a process for controlling the switching between position sycontrol and pressure control in the third example of press die cushion operation includes the process illustrated in the flowcharts in FIG. 12 and its continuation process illustrated in the flowchart in FIG. 15.

In the processing in Step a4 in the flowchart in FIG. 12, if the instruction in the block is determined to be a synchronization instruction G200, the process proceeds to Step a14 in the flowchart in FIG. 13 in the process for controlling the switching between position control and pressure control in the first example of press die cushion operation described above; in the process for controlling the switching between position control and pressure control in this third example of press die cushion operation, the process proceeds to Step c14 in the flowchart in FIG. 15, instead of Step a14 in the flowchart in FIG. 13.

[Step c14] A synchronization-instructed position of the slave axis corresponding to the position of the master axis is determined.

[Step c15] Whether synchronization is in pause or not is determined; if synchronization is in pause (YES), the process proceeds to Step c18; if synchronization is not in pause (NO), the process proceeds to Step c16.

[Step c16] Whether pressure control is in execution or not is determined; if pressure control is in execution (YES), the process proceeds to Step c17; if pressure control is not in execution (NO), the process proceeds to Step c25.

[Step c17] A synchronization pause flag is turned on and then the process proceeds to Step c18.

[Step c18] A point at which synchronization is to be resumed is determined from master axis data and the point of switching.

[Step c19] Whether synchronization is resumed or not is determined; if synchronization is resumed (YES), the process proceeds to Step c21; if synchronization is not resumed (NO), the process proceeds to Step c20.

[Step c20] Whether the master axis reaches or not the point at which synchronization is to be resumed is determined; if it has reached the point (YES), the process proceeds to Step c21; if it has not reached the point (NO), the process proceeds to Step c32.

[Step c21] A difference from the instructed position of the slave axis to the synchronization-instructed position of the slave axis is determined.

[Step c22] Whether synchronization is resumed for the first time or not is determined; if synchronization is resumed for the first time (YES), the process proceeds to Step c23; if synchronization is resumed not for the first time (NO), the process proceeds to Step c24.

[Step c23] The quantity of movement to be output up to the vicinity of the synchronization-instructed position is determined and then the process proceeds to Step c27.

[Step c24] The quantity of movement to be output is determined on the basis of the speed of the master axis and then the process proceeds to Step c27.

[Step c25] A difference from the instructed position of the slave axis to the synchronization-instructed position of the slave axis is determined.

[Step c26] The quantity of movement to be output is determined.

[Step c27] The instructed position of the slave axis is updated by adding the quantity of movement to be output determined in Step c23, c24, or c26 to the instructed position of the slave axis (instructed position of slave axis←instructed position of slave axis+quantity of movement to be output).

[Step c28] Whether synchronization is in pause or not is determined; if synchronization is in pause (YES), the process proceeds to Step c29; if synchronization is not in pause (NO), the process proceeds to Step c31.

[Step c29] Whether position control is in execution or not is determined; if position control is in execution (YES), the process proceeds to Step c30; if position control is not in execution (NO), the process proceeds to Step c31.

[Step c30] The synchronization pause flag is turned off and then the process proceeds to Step c31.

[Step c31] The quantity of movement to be output is output to the servo control section.

[Step c32] Whether synchronization is continued or not is determined; if synchronization is continued (YES), the process returns to Step c14 to continue the process; if synchronization is not continued (NO), the process returns to Step al in FIG. 12.

1. A numerical controller having a function for switching between pressure control and position control, the numerical controller comprising:
a servo control section that controls a servo motor by automatically switching between position control and pressure control by selecting an instruction obtained through position feedback control or an instruction obtained through pressure feedback control, whichever has a smaller instruction value; and
a numerical control section that determines a position of a slave axis with respect to a position of a master axis and outputs a position instruction for the slave axis to the servo control section in order to achieve position control so that the position of the slave axis synchronously follows the position of the master axis;
wherein the servo control section notifies the numerical control section whether the servo control section is under position control or pressure control;
wherein, when the numerical control section is notified by the servo control section that switching from position control to pressure control has taken place during execution of position control, the numerical control section places the position control in a synchronization pause state in which the position of the slave axis with respect to position of the master axis is determined but output of the position instruction for the slave axis to the servo control section is stopped, and resumes position control by resuming the output of the position instruction for the slave axis at a predetermined position of the master axis or the slave axis or at a predetermined timing.

2. The numerical controller according to claim 1, wherein the numerical control section is configured to gradually output instructed quantities of movement up to a synchronization-instructed route of the slave axis according to a speed of the master axis when resuming the output of the position instruction for the slave axis.

3. The numerical controller according to claim 1, wherein the numerical control section is configured to specify a position of the master axis at which switching from pressure control to position control takes place, determine, from the specified position of the master axis at which the switching takes place, a position at which the output of the position instruction for the slave axis is resumed, and resume the output of the position instruction for the slave axis at the determined position.
